(19) United States
(12) Patent Application Publication
(10) Pub. No.: US 2025/0347964 A1
(43) Pub. Date: Nov. 13, 2025

(54) DISPLAY PANEL AND ELECTRONIC TERMINAL

(71) Applicant: WUHAN CHINA STAR OPTOELECTRONICS TECHNOLOGY CO., LTD., Wuhan, Hubei (CN)

(72) Inventor: Liwang LIU, Wuhan, Hubel (CN)

(21) Appl. No.: 17/999,577

(22) PCT Filed: Nov. 4, 2022
(86) PCT No.: PCT/CN2022/129837

§ 371 Date: Jan. 3, 2025

(30) Foreign Application Priority Data
Aug. 26, 2022 (CN) 202211031109.2

(51) Int. Cl. G02F 1/1362; G02F 1/1368

(52) U.S. Cl. CPC G02F 1/136286; G02F 1/1368

(57) ABSTRACT

Disclosed are a display panel and an electronic terminal, wherein each of pixel repeating units includes three sub-pixel columns arranged in a row direction, each of the sub-pixel columns includes a plurality of sub-pixels arranged in a column direction, one of source lines, disposed between a first pixel repeating unit and a second pixel repeating unit adjacent to the first pixel repeating unit, is connected to a first sub-pixel column and a third sub-pixel column of the second pixel repeating unit, and a second sub-pixel column of the first pixel repeating unit, respectively through first transistors, third transistors, and second transistors.

### TECHNICAL FIELD

The present disclosure relates to the field of display technologies, and in particular, to the field of manufacturing a display panel, and more specifically, to a display panel and an electronic terminal.

### BACKGROUND

Demux (Demultiplexer) technologies can be applied to decompose a signal channel into a plurality of signal channels to effectively reduce the number of lines, which is essential in the small-size development of a display panel.

In order to further reduce the frame of the display panel, the Demux may be moved from a non-display area to a display area. However, in the case of applying the technique of setting Demux in the display area to source lines with column inversion, at least one sub-pixel in a pixel unit needs to be connected to the source lines for transmitting data signals having a corresponding polarity by such connection line that spans more than one pixel unit, wherein the connection line having an excessive length occupies a larger area in the pixel unit, resulting in a lower opening rate of the display panel.

Therefore, there is an urgent need to improve the problem of low opening rate in the existing display panel caused by setting Demux in the display area.

### TECHNICAL PROBLEM

Embodiments of the present disclosure provide a display panel and an electronic terminal, so as to solve the technical problem of low opening rate caused by setting the Demux in the display area and by setting the relative long connection line in the existing display panel.

### TECHNICAL SOLUTIONS

To solve the above technical problem, embodiments of the present disclosure provide a display panel including:
a plurality of pixel repeating units, each comprising a first sub-pixel column, a second sub-pixel column, and a third sub-pixel column arranged in a row direction, wherein the first sub-pixel column comprises a plurality of first sub-pixels arranged in a column direction, the second sub-pixel column comprises a plurality of second sub-pixels arranged in the column direction, the third sub-pixel column comprises a plurality of third sub-pixels arranged in the column direction, and the plurality of pixel repeating units comprise a first pixel repeating unit and a second pixel repeating unit disposed adjacent to the first pixel repeating unit; and
a plurality of source lines, wherein one of the source lines is disposed between the first pixel repeating unit and the second pixel repeating unit,
wherein the one of the source lines is electrically connected to the first sub-pixel column of the second pixel repeating unit through a plurality of first transistors, the one of the source lines is electrically connected to the third sub-pixel column of the second pixel repeating unit through a plurality of third transistors, and the one of the source lines is electrically connected to the second sub-pixel column of the first pixel repeating unit through a plurality of second transistors.

### BENEFICIAL EFFECT

The present disclosure provides a display panel and an electronic terminal, including a plurality of pixel repeating units, each including a first sub-pixel column, a second sub-pixel column, and a third sub-pixel column arranged in the row direction, wherein the first sub-pixel column includes a plurality of first sub-pixels arranged in the column direction, the second sub-pixel column includes a plurality of second sub-pixels arranged in the column direction, the third sub-pixel column includes a plurality of third sub-pixels arranged in the column direction, and the plurality of pixel repeating units include a first pixel repeating unit and a second pixel repeating unit disposed adjacent to each other; a plurality of source lines, wherein one of the source lines is disposed between the first pixel repeating unit and the second pixel repeating unit. The one of the source lines is electrically connected to a first sub-pixel column of the second pixel repeating unit through one of first transistors, the one of the source lines is electrically connected to a third sub-pixel column of the second pixel repeating unit through one of third transistors, and the one of the source lines is electrically connected to a second sub-pixel column of the first pixel repeating unit through one of second transistors. By this configuration, it avoids each sub-pixel column to span the adjacent source line to connect the other source lines which are far away, effectively shortens the connection path of multiple sub-pixel columns in the corresponding pixel repetition units to the source lines based on the “proximity principle”, thereby reducing the area occupied by the connection path in the light transmission area and increasing the opening rate of the corresponding pixel repetition units.

### BRIEF DESCRIPTION OF THE DRAWINGS

In order to more clearly illustrate the technical solutions in the embodiments or prior art, the following is a brief description of the drawings to be used in the embodiments or prior art. It will be apparent that the drawings in the following description are only some embodiments of the present disclosure, and other drawings can be obtained from these drawings without creative effort for those of ordinary skill in the art.

FIG. 1 is a schematic top view of line connection between pixel units and source lines or the like in a display panel according to the present disclosure.

FIG. 2 is a circuit design diagram corresponding to FIG. 2.

FIG. 3 is a schematic diagram of a line connection relationship between pixel units and source lines or the like in a display panel according to the present disclosure.

### DETAILED DESCRIPTION OF THE EMBODIMENTS

Technical solutions in the embodiments of the present disclosure will be clearly and completely described with reference to the accompanying drawings. It will be apparent that the described embodiments are only some examples of the present disclosure, and not all examples. Based on the embodiments in the present disclosure, all other embodiments obtained by a person skilled in the art without involving any creative effort are within the scope of the present disclosure.

The terms, such as “first” and “second” as used herein, are used to distinguish between different objects, and not to describe a particular order. Furthermore, the terms “include”, “comprise”, “have” and any variations thereof are intended to encompass non-exclusive inclusion. For example, a process, method, system, product, or apparatus that includes a series of steps or modules is not limited to the listed steps or modules, but optionally further includes steps or modules that are not listed, or optionally further includes other steps or modules inherent to such process, method, product, or apparatus.

Reference herein to “embodiment” means that a particular feature, structure, or characteristic described in connection with the embodiment may be included in at least one embodiment of the present disclosure. The occurrence of the phrase at various time and positions in the specification is not necessarily an indication to the same embodiment, and not to a separate or alternative embodiment that conflicts with other embodiments. It will be explicitly and implicitly understood by those skilled in the art that the embodiments described herein may be combined with other embodiments.

The present disclosure will be further described below with reference to the accompanying drawings and specific embodiments. Embodiments of the present disclosure provide a display panel including, but not limited to, a display panel described in the following embodiments and a combination of the following embodiments.

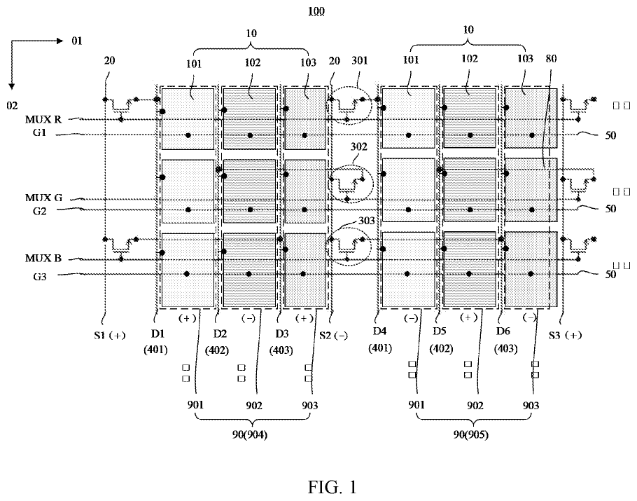

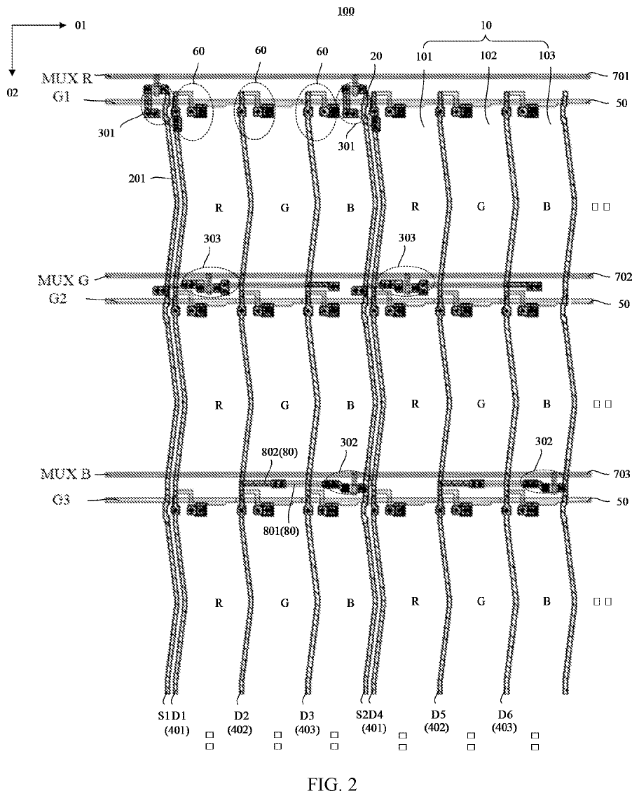

In one embodiment, in conjunction with FIGS. 1 and 2, there is provided a display panel 100, which includes: a plurality of pixel units 10, each of which at least includes first sub-pixels 101, second sub-pixels 102, and third sub-pixels 103 arranged in a row direction; and a plurality of source lines 20 electrically connected between a source driving circuit and the corresponding pixel units 10, wherein one of the source lines 20 is disposed between two adjacent columns of pixel units 10. In two adjacent source lines 20, one of the source lines 20 is connected by a plurality of first demultiplexers 301 to the plurality of first sub-pixels 101 in a column of pixel units 10 adjacent to a side of the one of the source lines 20, and is connected by a plurality of third demultiplexers 303 to the plurality of third sub-pixels 103 in the column of pixel units 10 adjacent to the side of the one of the source lines 20, as well as is connected by a plurality of second demultiplexers 302 to the plurality of second sub-pixels 102 in a column of pixel units 10 adjacent to the other side of the one of the source lines 20.

Further, in one of the pixel units 10, polarity of the first sub-pixels 101 is opposite to polarity of the second sub-pixels 102, and the polarity of the first sub-pixels 101 is same as polarity of the third sub-pixels 103. In two adjacent pixel units 10, polarity of the third sub-pixels 103 in one of the pixel units 10 is opposite to polarity of the first sub-pixels 101 in the other one of the pixel units 10.

The plurality of pixel units 10 may be divided into a plurality of pixel repeating units 90, each including a first sub-pixel column 901, a second sub-pixel column 902, and a third sub-pixel column 903 arranged in a row direction. The first sub-pixel column 901 includes the plurality of first sub-pixels 101 arranged in a column direction, the second sub-pixel column 902 includes the plurality of second sub-pixels 102 arranged in the column direction, and the third sub-pixel column 903 includes the plurality of third sub-pixels 103 arranged in the column direction. The plurality of pixel repeating units 90 include a first pixel repeating unit 904 and a second pixel repeating unit 905 disposed adjacent to the first pixel repeating unit 904. One of the source lines 20 is disposed between the first pixel repeating unit 904 and the second pixel repeating unit 905. It can be considered that any adjacent two pixel repeating units 90 may be defined as the first pixel repeating unit 904 and the second pixel repeating unit 905, respectively.

However, it is to be noted that a relative position between the first pixel repeating unit 904 and the adjacent second pixel repeating unit 905 should be the same, in order to shorten the connection paths of each source line 20 with the first sub-pixel column 901, the second sub-pixel column 902 and the third sub-pixel column 903 to be connected. Based on the above division, it can be considered that each source line 20 is electrically connected to the first sub-pixel column 901 in the second pixel repeating unit 905 through a plurality of the first transistors (included in the first demultiplexers 301), electrically connected to the third sub-pixel column 903 in the second pixel repeating unit 905 through a plurality of the third transistors (included in the third demultiplexers 303), and electrically connected to the second sub-pixel column 902 in the first pixel repeating unit 904 through a plurality of the second transistors (included in the second demultiplexers 302).

The display panel 100 may be, but is not limited to, a liquid crystal display panel. The display panel 100 may include an array substrate, a color film substrate opposite to the array substrate, and a liquid crystal layer between the array substrate and the color film substrate. The array substrate may include, but is not limited to, a substrate, a plurality of pixel units 10 and a plurality of source lines 20 located on a side of the substrate adjacent to the liquid crystal layer. Here, in consideration of mitigating a polarization phenomenon of liquid crystal molecules in the liquid crystal layer to prolong the lifetime of the liquid crystal layer, the display panel 100 may be set into column inversion driving. In each frame of images, in conjunction with the above description, two adjacent columns of sub-pixels have opposite polarities to each other. In other words, the odd numbered columns of sub-pixels have one of positive and negative polarities, and the even numbered columns of sub-pixels have the other one of positive and negative polarities, so as to mitigate the polarization phenomenon of liquid crystal molecules mentioned above. Further, the source lines 20 are electrically connected between the source driving circuit and the corresponding pixel units 10. It can be considered that the source driving circuit may generate a data voltage corresponding to each sub-pixel in each pixel unit 10 according to the display data of images, and may transmit the data voltage to the corresponding sub-pixel in the corresponding pixel unit 10 through the source lines 20.

Specifically, in conjunction with FIG. 1 and FIG. 2, the plurality of pixel units 10 may be arranged in a matrix in a first direction 01 and a second direction 02. For example, the first direction 01 may be a horizontal direction, and the second direction 02 may be a vertical direction. Further, the first sub-pixels 101, the second sub-pixels 102, and the third sub-pixels 103 in each pixel unit 10 may be arranged in sequence in the first direction 01. Here, the first direction 01 may be horizontally left or right, and the second direction 02 may be vertically upward or downward, which is not limited thereto. In conjunction with the above description, the first direction 01 may be understood as the “row direction” mentioned above. That is, the “row direction” can be a horizontal left or right direction. Similarly, the second direction 02 can be understood as a column direction.

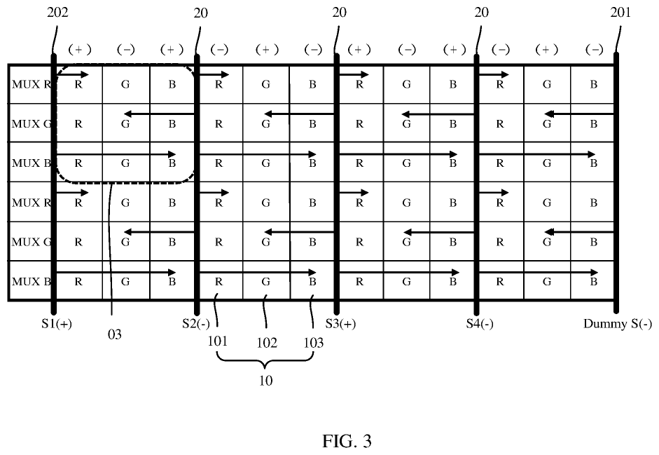

Specifically, in the present embodiment, each source line 20 is disposed between two adjacent columns of pixel units 10. As shown in FIGS. 1 and 2, one source line 20 (S2) is disposed between a first column of pixel units 10 and a second column of pixel units 10. Certainly, a third column of pixel units 10, for example, may be disposed. Another source line 20 (S3) may be considered to be located between the second column of pixel units 10 and a third column of pixel units 10, and so on. Further, in the present embodiment, in two adjacent source lines 20, one of the source lines 20 is connected by the plurality of first demultiplexers 301 to the plurality of first sub-pixels 101 in a column of pixel units 10 adjacent to a side of the one of the source lines 20, and is connected by the plurality of third demultiplexers 303 to the plurality of third sub-pixels 103 in the column of pixel units 10 adjacent to the same side of the one of the source lines 20, as well as is connected by the plurality of second demultiplexers 302 to the plurality of second sub-pixels 102 in a column of pixel units 10 adjacent to the other side of the one of the source lines 20. As shown in FIGS. 1 to 3, in the case of the presence of the third column of pixel units 10 (not shown in FIGS. 1 and 2, but shown in FIG. 3), two adjacent source lines 20 (S2 and S3) may be conformed to the following: one of the source lines 20 is connected to the plurality of first sub-pixels 101 (R) in a column of pixel units 10 at the right thereof through the plurality of first demultiplexers 301, and is connected to the plurality of third sub-pixels 103 (B) in a column of pixel units 10 at the right thereof through the plurality of third demultiplexers 303, as well as is connected to the plurality of second sub-pixels 102 (G) in a column of pixel units 10 at the left thereof through the plurality of second demultiplexers 302. In the embodiment, the correspondence between the first sub-pixels 101, the second sub-pixels 102, and the third sub-pixels 103, and R (red sub-pixels), G (green sub-pixels), and B (blue sub-pixels) is not limited. Certainly, at least one of the first sub-pixels 101, the second sub-pixels 102, and the third sub-pixels 103 may be sub-pixels of another color.

As can be appreciated, in conjunction with FIGS. 1 to 3, based on the connection rule of two adjacent source lines 20 to the pixel units 10 set as above in the present embodiment, the plurality of sub-pixels in a corresponding column of pixel units 10 can be connected to adjacent source lines 20 (on the left or right side of a plurality of second sub-pixels 102), respectively, while preventing connection lines from spanning the adjacent one of the source lines 20 and connecting the other source lines 20 which are far away. By this “proximity principle”, the connection paths of the plurality of sub-pixels in the corresponding column of pixel units 10 to the source lines 20 are effectively shortened, thereby reducing the occupation area of these connection paths in the light transmission region, and improving the opening rate of the corresponding pixel units 10.

It is to be noted that, in connection with the above description of the polarities of sub- pixels within the same pixel unit 10 or different pixel units 10, and the description of the connection rule of two adjacent source lines 20 to the pixel units 10, it can be concluded that the polarities of the voltages transmitted by two adjacent source lines 20 with the above connection rule are opposite to each other. For example, as shown in FIG. 3, the polarities of the three columns of sub-pixels in the first column of pixel units 10 from left to right may be positive polarity, negative polarity, and positive polarity, respectively. Since the second column of pixel units 10 is adjacent to the first column of pixel units 10, the polarities of the three columns of sub-pixels in the second column of pixel units 10 from left to right may be negative polarity, positive polarity, negative polarity, respectively. In conjunction with the electrical connection relationship between the source polarity lines 20 and the multi-column sub-pixels, one of the source lines 20 (S2) may have a negative polarity and another one of the source lines 20 (S3) may have a positive polarity.

Specifically, based on the above description, one of the source lines 20 (S2) may be connected to the plurality of first sub-pixels 101 (R) and the plurality of third sub-pixels 103 (B) in the second column of pixel units 10 located on the right thereof, and connected to the plurality of second sub-pixels 102 (G) in the first column of pixel units 10 located on the left thereof, so as to provide a voltage of negative polarity. Similarly, another one of the source lines 20 (S3) may be connected to the plurality of first sub-pixels 101 (R) and the plurality of third sub-pixels 103 (B) in the third column of pixel units 10 located on the right thereof, and connected to the plurality of second sub-pixels 102 (G) in the second column of pixel units 10 located on the left thereof, so as to provide a voltage of positive polarity. In another perspective, for example, in FIG. 3, the second sub-pixels 102 positioned at a non-end portion in at least the second and third column of pixel units 10 may be respectively connected to a corresponding one (i.e., S3, or S4) of the source lines 20 on the right of the second sub-pixels 102, so as to be loaded the corresponding positive polarity voltage and the corresponding negative polarity voltage, and to avoid the problem of low opening rate of the pixel units 10 caused by excessively long connection paths of the second sub-pixels 102 due to spanning the adjacent source lines 20 having a voltage of the opposite polarity and connecting to the source lines 20 having a voltage of the same polarity.

In an embodiment, in conjunction with FIGS. 1 to 3, the display panel 100 further includes a first auxiliary source line 201 disposed on a side of the plurality of pixel repeating units 90. The first auxiliary source line 201 is connected to the second sub-pixel column 902 in one of the pixel repeating units 90 adjacent to the first auxiliary source line 201 through the plurality of second transistors (included in the second demultiplexers 302).

Further, the first auxiliary source line 201 (Dummy S), which is electrically connected to the source driving circuit, is disposed on a side of the last column of pixel units 10 far from the remaining multiple columns of pixel units 10, and connected to the plurality of second sub-pixels 102 in the last column of pixel units 10 through the second demultiplexers 302. Specifically, in conjunction with the above description, for example, with four columns of pixel units 10 and three source lines 20 (S1, S2, S3) exemplified in FIG. 3 as an example, the last one of the source lines 20 (S4) adjacent to the last column of pixel units 10 can be connected to the plurality of first sub- pixels 101 (R) and the plurality of third sub-pixels 103 (B) in the last column of pixel units 10 to supply a voltage of same polarity (negative polarity), but cannot supply a voltage of opposite polarity (positive polarity) to the plurality of second sub-pixels 102 (G) in the last column of pixel units 10.

It is to be understood that, in conjunction with FIG. 3, two adjacent source lines 20 complying with the connection rule as above described at least include the last one of the source lines 20 (S4). In the present embodiment, The additionally provided first auxiliary source line 201 (Dummy S), located on a side of the last column of pixel units 10 far away from the remaining multiple columns of pixel units 10, may be connected to the plurality of second sub-pixels 102 in the last column of pixel units 10 through the corresponding second demultiplexers 302, so as to provide a voltage having polarity opposite to polarity of the last one of the source lines 20 (S4) and to match the polarity required for the plurality of second sub-pixels 102 (G) in the last column of pixel units 10.

In an embodiment, in conjunction with FIGS. 1 to 3, the display panel 100 further includes a second auxiliary source line 202 disposed on the other side of the plurality of pixel repeating units 90. The second auxiliary source line 202 is connected to the first sub-pixel column 901 and the third sub-pixel column 903 in one of the pixel repeating units 90 adjacent to the second auxiliary source line 202 respectively through the first plurality of transistors (included in the first demultiplexers 301) and the plurality of third transistors (included in the third demultiplexers 303).

Further, the second auxiliary source line 202 (S1) is disposed on a side of the first column of pixel units 10 far away from the remaining columns of pixel units 10. The second auxiliary source line 202 (S1) is electrically connected to the source driving circuit, and is connected to the plurality of first sub-pixels 101 and the plurality of third sub-pixels 103 in the first column of pixel units 10 respectively through the plurality of first demultiplexers 301 and the plurality of third demultiplexers 303. Similarly, in combination with the above description, the first one of the source lines 20 (S2) can be connected to the plurality of second sub-pixels 102 (G) in the first column of pixel units 10 adjacent thereto, so as to provide a voltage of the same polarity (negative polarity), but cannot provide a voltage of opposite polarity (positive polarity) to the plurality of first sub-pixels 101 (R) and the plurality of third sub-pixels 103 (B) in the first column of pixel units 10.

Similarly, in conjunction with FIGS. 1 to 3, two adjacent source lines 20 complying with the above-mentioned connection rule at least include the first one of the source lines 20 (S2). In the present embodiment, the above-mentioned and additionally provided second auxiliary source line 202 (S1) may also supply a voltage of polarity opposite to the first one of the source lines 20 (S2) to the plurality of first sub-pixels 101 (R) and the plurality of third sub-pixels 103 (B) in the first column of pixel units 10 through the plurality of second demultiplexer 302.

Based on the above-mentioned arrangement of the first auxiliary source line 201 (Dummy S) and the second auxiliary source line 202 (S1), any two adjacent source lines 20 may be further arranged to comply with the above-mentioned connection rule. In conjunction with the above description, it may realize that each sub-pixel in each column of pixel units 10 may be connected to an adjacent one of the source lines 20, the first auxiliary source line 201 (Dummy S), or the second auxiliary source line 202 (S1) located on the left or right side thereof, so that the connection path of each sub-pixel to one source line 20, the first auxiliary source line 201 (Dummy S), or the second auxiliary source line 202 (S1) may be effectively shortened, thereby increasing the opening rate of the pixel units 10.

In an embodiment, in conjunction with FIGS. 1 to 3, the display panel 100 further includes a plurality of data lines, which include a first data line 401 electrically connected to the first sub-pixel column 901 in the second pixel repeating unit 905, a third data line 403 electrically connected to the third sub-pixel column 903 in the second pixel repeating unit 905, and a second data line 402 electrically connected to the second sub-pixel column 902 in the first pixel repeating unit 904. The first transistors (included in the first demultiplexers 301) are electrically connected to the first data line 401, the second transistors (included in the second demultiplexers 302) are electrically connected to the second data line 402, and the third transistors (included in the third demultiplexers 303) are electrically connected to the third data line 403.

Alternatively, it is to be understood that the display panel 100 further includes a plurality of data lines, which include a plurality of first data lines 401 (e.g., D1, D4), a plurality of second data lines 402 (e.g., D2, D5), and a plurality of third data lines 403 (e.g., D3, D6). One of the first data lines 401, one of the second data lines 402, and one of the third data lines 403 are located between two adjacent source lines 20, and respectively electrically connected to the first sub-pixels 101, the second sub-pixels 102, and the third sub-pixels 103 of one of the pixel units 10 located between the two adjacent source lines 20 (e.g., D1, D2, D3 are connected to three sub-pixels in the first column of pixel units 10, and D4, D5, D6 are connected to three sub-pixels in the second column of pixel units 10). The first demultiplexers 301 are configured to control the corresponding first data lines 401 to be electrically connected to the corresponding source lines 20, the second demultiplexers 302 are configured to control the corresponding second data lines 402 to be electrically connected to the corresponding source lines 20, and the third demultiplexers 303 are configured to control the corresponding third data lines 403 to be electrically connected to the corresponding source lines 20.

Specifically, in conjunction with FIGS. 1 and 2, the display panel further provides a plurality of gate lines 50 (e.g., G1, G2, G3) and a plurality of driving transistors 60. The plurality of gate lines 50 and the plurality of data lines are intersected with each other, so as to define a plurality of regions for forming sub-pixels. Each of the sub-pixels emits light under the action of one of the driving transistors 60. Further, the plurality of gate lines 50 may extend in the row direction and be arranged in the column direction, and the plurality of data lines may extend in the column direction and be arranged in the row direction. Further, as shown in FIG. 3, the gates of the plurality of driving transistors 60 corresponding to the same row of sub-pixels may be electrically connected to one of the gate lines 50, the sources of the plurality of driving transistors 60 corresponding to a same column of sub-pixels may be electrically connected to one of the data lines (e.g., the first data lines 401, the second data lines 402, or the third data lines 403), and the drains of the driving transistor 60 may be electrically connected to the corresponding sub-pixels. It is to be noted that the driving transistors 60 will inevitably occupy an area that can be used to form corresponding or adjacent sub-pixels, and thus the opening rate of the pixel units 10 may be reduced.

Under the control of the gate voltage transmitted by the plurality of gate lines 50, multiple rows of the driving transistors 60 corresponding to multiple rows of the pixel units 10 are turned on in sequence, so that the data voltage on the plurality of data lines can be transmitted to the plurality of sub-pixels in the corresponding row of pixel units 10 through a row of driving transistors 60 which are turned on. Furthermore, with FIG. 1 and FIG. 2 as an example, a plurality of data lines (the first data lines 401, the second data lines 402, and the third data lines 403), which correspond to a plurality of sub-pixels (R, G, and B) in the pixel units 10 one by one, are provided in the present embodiment. Herein, taking one of the first data lines 401 (D4), one of the second data lines 402 (D5), and one of the third data lines 403 (D6), which correspond to the second column of pixel units 10, as an example, the first demultiplexers 301, the second demultiplexers 302, and the third demultiplexers 303 are connected to the corresponding two source lines 20 (S2, S3), wherein only one of the three can be turned on, so as to enable the corresponding sub-pixels to be electrically connected to the corresponding one of the source lines 20 (S2 or S3) through one of the data lines, and to be loaded the corresponding data voltages, regardless of which row of the driving transistors 60 is turned on. Then, the other two demultiplexers are turned on in sequence to enable the other sub-pixels to emit light. It is to be noted that each sub-pixel can maintain light emission until the end of this frame of images under the action of a corresponding storage voltage.

Further, in conjunction with the above description, based on the arrangement of the first auxiliary source line 201 (Dummy S) and the second auxiliary source line 202 (S1), the first demultiplexers 301 may also be configured to control the corresponding first data lines 401 to be electrically connected to the corresponding first auxiliary source line 201 (Dummy S) or the second auxiliary source line 202 (S1). The second demultiplexers 302 may also be configured to control the corresponding second data lines 402 to be electrically connected to the corresponding first auxiliary source line 201 (Dummy S) or the second auxiliary source line 202 (S1). The third demultiplexers 303 may also be configured to control the corresponding third data lines 403 to be electrically connected to the corresponding first auxiliary source line 201 (Dummy S) or the second auxiliary source line 202 (S1).

In an embodiment, in conjunction with FIGS. 1 to 3, the first demultiplexers 301 include the first transistors, the second demultiplexers 302 include the second transistors, and the third demultiplexers 303 include the third transistors. Further, the display panel includes first demultiplexing lines 701 (MUX R), wherein the gates of the first transistors are electrically connected to the first demultiplexing lines 701 (MUX R), the sources of at least one of the first transistors corresponding to one of the pixel repeating units 90 (i.e., a same column of the pixel units 10) are electrically connected to the corresponding one of the source lines 20, and the drains of at least one of the first transistors corresponding to one of the pixel repeating units 90 (i.e., a same column of the pixel units 10) are electrically connected to one of the first data lines 401; second demultiplexing lines 702 (MUX G), wherein the gates of the second transistors are electrically connected to the second demultiplexing lines 702 (MUX G), the sources of at least one of the second transistors corresponding to one of the pixel repeating units 90 (i.e., a same column of the pixel units 10) are electrically connected to one of the source lines 20, and the drains of at least one of the second transistors corresponding to one of the pixel repeating units 90 (i.e., a same column of the pixel units 10) are electrically connected to one of the second data lines 402; third demultiplexing lines 703 (MUX B), wherein the gates of the third transistors are electrically connected to the third demultiplexing lines 703 (MUX B), the sources of at least one of the third transistors corresponding to one of the pixel repeating units 90 (i.e., a same column of the pixel units 10) are electrically connected to one of the source lines 20, and the drains of at least one of the third transistors corresponding to one of the pixel repeating units 90 (i.e., a same column of the pixel units 10) are electrically connected to one of the third data lines 403.

It is to be noted that, in conjunction with the above description, since the multiple rows of the driving transistors 60 are turned on in sequence, when one row of the driving transistors 60 is turned on, the data voltage in the source lines 20 is loaded onto the corresponding one of the first sub-pixels 101 (R), the corresponding one of the second sub-pixels 102 (G), or the corresponding one of the third sub-pixels 103 (B) sequentially through the corresponding one of the first demultiplexers 301, the corresponding one of the second demultiplexers 302, or the corresponding one of the third demultiplexers 303, and the driving transistors 60 in an on state, even if only the corresponding one of the first demultiplexers 301, the corresponding one of the second demultiplexers 302, or the corresponding one of the third demultiplexers 303 is disposed to correspond to the same column of pixel units 10 to enable the source lines 20 to be electrically connected to a plurality of first sub-pixels 101 (R), a plurality of second sub-pixels 102 (G), or a plurality of third sub-pixels 103 (B) corresponding to a column of pixel units 10,

In an embodiment, in conjunction with FIGS. 1 to 3, the pixel units 10 in different rows are connected to the same one of the first demultiplexing lines, the same one of the second demultiplexing lines, and the same one of the third demultiplexing lines. Alternatively, the plurality of first sub-pixels 101 located in the same row in the plurality of pixel repeating units 90 are connected to the same one of the first demultiplexing lines, the plurality of second sub-pixels 102 located in the same row in the plurality of pixel repeating units 90 are connected to the same one of the second demultiplexing lines, and the plurality of third sub-pixels 103 located in the same row in the plurality of pixel repeating units 90 are connected to the same one of the third demultiplexing lines. The second manner can also be understood that one of the first demultiplexing lines is connected to the plurality of first sub-pixels 101 in a corresponding row of the pixel units 10, one of the second demultiplexing lines is connected to the plurality of second sub-pixels 102 in a corresponding row of the pixel units 10, and one of the third demultiplexing lines is connected to the plurality of third sub-pixels 103 in a corresponding row of the pixel units 10.

Specifically, the first demultiplexers 301 and the first sub-pixels 101 (R) will be described herein as an example. In conjunction with the above description, due to the clamping effect of the driving transistors 60 in each row, it will be exclusively presented that the data voltage in the source lines 20 is loaded onto the corresponding sub-pixels, regardless of the solution that the only corresponding one of the first demultiplexers 301 is disposed for the same column of pixel units 10 to realize that one of the source line 20 is electrically connected to a plurality of first sub-pixels 101 (R) in the corresponding column of pixel units 10, that is, the above-mentioned scheme that “the pixel units 10 of different rows are connected to the same one of the first demultiplexing lines, the same one of the second demultiplexing lines, and the same one of the third demultiplexing lines”, or the solution that the corresponding plurality of first demultiplexers 301 are disposed for the same column of pixel units 10 to realize that the corresponding one of the source lines 20 is electrically connected to a plurality of first sub-pixels 101 (R) in the corresponding column of pixel units 10, that is, the above-mentioned scheme that “the first demultiplex lines are connected to a plurality of first sub-pixels 101 in a corresponding row of pixel units 10”. The number of the corresponding first demultiplexers 301 disposed for the same column of pixel units 10 may be less than or equal to the number of the first sub-pixels 101 (R) in the corresponding column of pixel units 10. That is, each first demultiplexer 301 may control one or more first sub-pixels 101 (R).

The first demultiplexing lines 701 (MUX R) and the first transistors will be described herein as an example. In conjunction with the above description, one of the first demultiplexing lines 701 (MUX R) may be disposed at the first transistors in the same row or multiple rows, and the first demultiplexing signal transmitted by the corresponding one of the first demultiplexing lines 701 (MUX R) may control the first transistors in the same row or multiple rows to be turned on or off. That is, the gates of the first transistors in the same row or multiple rows are electrically connected to the corresponding one of the first demultiplexing lines 701 (MUX R). In conjunction with the above description, the sources of at least one of the first transistors corresponding to the same column of pixel units 10 may also be electrically connected to the corresponding first auxiliary source line 201 (Dummy S) or to the corresponding second auxiliary source line 202 (S1). The second transistors and the third transistors may also be arranged accordingly.

Specifically, in conjunction with FIGS. 1 to 3, each group of demultiplexing lines (MUX R, MUX G, MUX B) may be disposed to correspond to three rows of pixel units 10. The first demultiplexing lines 701 (MUX R), the second demultiplexing lines 702 (MUX G), and the third demultiplexing lines 703 (MUX B) in each group of demultiplexing lines may be connected to the corresponding three rows of pixel units 10 through the corresponding first demultiplexer(s) 301, the corresponding second demultiplexer(s) 302, and the corresponding third demultiplexer(s) 303, respectively. As shown in FIG. 3, in this case, the three successive rows of pixel cells 10 and their connection layout with the corresponding “two adjacent source lines 20”, “adjacent one of the source lines 20 (S4) and the first auxiliary source line 201 (Dummy S)” or “adjacent one of the source lines 20 (S2) and the second auxiliary source line 202 (S1)” can be presented as a minimum repeating unit 03.

In an embodiment, in conjunction with FIGS. 1 to 3, all of the first demultiplexers 301, the second demultiplexers 302, and the third demultiplexers 303 are located in a display area. Specifically, the plurality of demultiplexing lines may be disposed parallel to the plurality of gate lines 50, and each demultiplexing line may be disposed adjacent to one of the gate lines 50 or corresponding to one of the gate lines 50. The plurality of source lines 20 may be disposed parallel to the plurality of data lines, and each of the source lines 20 is located between two adjacent columns of pixel units 10. Further, all of the first demultiplexers 301, the second demultiplexers 302, and the third demultiplexers 303 are disposed in the display area, and each demultiplexer is further disposed close to the corresponding demultiplexing line(s), the corresponding source line(s) 20, and the corresponding data line(s), so that each demultiplexer is connected to the corresponding demultiplexing line, the corresponding source line 20, and the corresponding data line.

In an embodiment, in conjunction with FIGS. 1 to 3, one of the first data lines 401, one of the second data lines 402, and one of the third data lines 403 between two adjacent source lines 20 are arranged in the row direction. There is further provided connection lines 80, each spanning the corresponding one of the third data lines 403 to connect to the corresponding one of the second data lines 402 and the corresponding one of the second transistors. The “row direction” is used only to indicate a direction in which the first data lines 401, the corresponding second data lines 402, and the corresponding third data lines 403 are sequentially arranged, and the direction is the same as a direction in which the first sub-pixels 101, the second sub-pixels 102, and the third sub-pixels 103 in the same one of the pixel units 10 are sequentially arranged. As described above, the “row direction” may be horizontal to the left or right direction.

Specifically, as shown in FIGS. 1 and 2, each of the connection lines 80 spans the corresponding one of the third data lines 403 to connect the corresponding one of the second data lines 402 and the corresponding one of the second transistors. In conjunction with the above description that “the plurality of gate lines 50 and the plurality of data lines are intersected with each other to define the plurality of areas for forming sub-pixels”, it may also be considered that the connection lines 80, the plurality of demultiplexers, the plurality of demultiplexing lines, the plurality of source lines 20, the first auxiliary source line 201 (Dummy S), and the second auxiliary source line 202 (S1) occupy a part of the region used for the plurality of sub-pixels.

It is to be understood that, in connection with the above description, the connection paths of the plurality of sub-pixels in the corresponding column of pixel units 10 to the source lines 20 may be shortened by setting the connection rule of adjacent two source lines 20 to the corresponding pixel units 10. That is, the lengths of the connection lines 80 described in the present embodiment may be reduced by only spanning the corresponding one of the third data lines 403 without spanning other data lines to connect to the corresponding one of the second data lines 402 and the corresponding one of the second transistors.

In an embodiment, in conjunction with FIGS. 1 to 3, each of the connection lines 80 includes a first connection portion 801 disposed in a layer same as the corresponding one of the second transistors; a second connection portion 802 electrically connected to the first connection portion 801 through a via and disposed in a same layer as the corresponding one of the data lines. It is to be understood that since each of the connection lines 80 needs to span the corresponding one of the third data lines 403, a vertical projection of each connection line 80 in a plane at which the plurality of pixel units 10 are located overlaps with a vertical projection of the corresponding one of the third data lines 403 in some regions. Specifically, in the present embodiment, each of the connection lines 80 includes the first connection portion 801 and the second connection portion 802 disposed in different layers. In conjunction with the connection lines for the gates, sources and drains of the second transistors described above, it may further facilitate the connection of the first connection portion 801 to the drain of the corresponding one of the second transistors disposed in the same layer, and facilitate the connection of the second connection portion 802 to the corresponding one of the data lines disposed in the same level.

Further, as shown in FIG. 3, the plurality of gate lines 50, the first demultiplexing lines 701 (MUX R), the second demultiplexing lines 702 (MUX G), the third demultiplexing lines 703 (MUX B), and the drains of transistors constituting the demultiplexers are disposed in the same layer, and the source lines 20, the data lines, and the sources of the driving transistors 60 are disposed in the same layer.

An embodiment of the present disclosure further provides an electronic terminal including the display panel as described above.

The present disclosure provides a display panel and an electronic terminal, including: a plurality of pixel repeating units, each including a first sub-pixel column, a second sub-pixel column, and a third sub-pixel column arranged in the row direction, wherein the first sub-pixel column includes a plurality of first sub-pixels arranged in the column direction, the second sub-pixel column includes a plurality of second sub-pixels arranged in the column direction, the third sub-pixel column includes a plurality of third sub-pixels arranged in the column direction, and the plurality of pixel repeating units include a first pixel repeating unit and a second pixel repeating unit disposed adjacent to each other; a plurality of source lines, wherein one of the source lines is disposed between the first pixel repeating unit and the second pixel repeating unit. The one of the source lines is electrically connected to a first sub-pixel column of the second pixel repeating unit through one of first transistors, the one of the source lines is electrically connected to a third sub-pixel column of the second pixel repeating unit through one of third transistors, and the one of the source lines is electrically connected to a second sub-pixel column of the first pixel repeating unit through one of second transistors. By this configuration, it avoids each sub-pixel column to span the adjacent source line to connect the other source lines which are far away, effectively shortens the connection path of multiple sub-pixel columns in the corresponding pixel repetition units to the source lines based on the “proximity principle”, thereby reducing the area occupied by the connection path in the light transmission area and increasing the opening rate of the corresponding pixel repetition units.

The above embodiments of the present disclosure provide a detailed description of the display panel and electronic terminal, and specific examples are applied herein to illustrate the principles and implementation of the present disclosure. The above embodiments are only used to help understand the technical solution of the present application and its core ideas. It should be understood by those of ordinary skill in the art that it is still possible to modify the technical solutions recorded in the preceding embodiments, or to make equivalent substitutions for some of the technical features thereof. These modifications or substitutions do not make the essence of the corresponding technical solutions out of the scope of the embodiments of the present disclosure.

What is claimed is:

1. A display panel, comprising:
a plurality of pixel repeating units, each of the pixel repeating units comprising a first sub-pixel column, a second sub-pixel column, and a third sub-pixel column that are arranged in a row direction, wherein the first sub-pixel column comprises a plurality of first sub-pixels arranged in a column direction, the second sub-pixel column comprises a plurality of second sub-pixels arranged in the column direction, the third sub-pixel column comprises a plurality of third sub-pixels arranged in the column direction, and wherein the plurality of pixel repeating units comprise a first pixel repeating unit and a second pixel repeating unit disposed adjacent to the first pixel repeating unit; and
a plurality of source lines, wherein one of the source lines is disposed between the first pixel repeating unit and the second pixel repeating unit,
wherein the one of the source lines is electrically connected to the first sub-pixel column of the second pixel repeating unit through a plurality of first transistors, the one of the source lines is electrically connected to the third sub-pixel column of the second pixel repeating unit through a plurality of third transistors, and the one of the source lines is electrically connected to the second sub-pixel column of the first pixel repeating unit through a plurality of second transistors;
the display panel further comprising:
a first auxiliary source line, disposed on one side of the plurality of pixel repeating units and connected by the second transistors to the second sub-pixel column of one of the pixel repeating units adjacent to the first auxiliary source line; and
a plurality of data lines, comprising a first data line electrically connected to the first sub-pixel column of the second pixel repeating unit, a third data line electrically connected to the third sub-pixel column of the second pixel repeating unit, and a second data line electrically connected to the second sub-pixel column of the first pixel repeating unit;
wherein the first transistors are electrically connected to the first data line, the second transistors are electrically connected to the second data line, and the third transistors are electrically connected to the third data line.

2. The display panel according to claim 1, further comprising a second auxiliary source line disposed on the other side of the plurality of pixel repeating units, wherein the second auxiliary source line is connected to the first sub-pixel column and the third sub-pixel column of one of the pixel repeating units adjacent to the second auxiliary source line respectively through the plurality of first transistors and the plurality of third transistors.

3. The display panel according to claim 1, further comprising:
first demultiplexing lines, wherein gates of the plurality of first transistors are electrically connected to the first demultiplexing lines, sources of at least one of the first transistors corresponding to one of the pixel repeating units are electrically connected to one of the source lines, and drains of at least one of the first transistors corresponding to the one of the pixel repeating units are electrically connected to the corresponding first data line;
second demultiplexing lines, wherein gates of the plurality of second transistors are electrically connected to the second demultiplexing lines, sources of at least one of the second transistors corresponding to the one of the pixel repeating units are electrically connected to the corresponding one of the source lines, and drains of at least one of the second transistors corresponding to the one of the pixel repeating units are electrically connected to the corresponding second data line; and
third demultiplexing lines, wherein gates of the plurality of third transistors are electrically connected to the third demultiplexing lines, sources of at least one of the third transistors corresponding to the one of the pixel repeating units are electrically connected to the corresponding one of the source lines, and drains of at least one of the third transistors corresponding to the one of the pixel repeating units are electrically connected to the corresponding third data line.

4. The display panel according to claim 3, wherein all of the first transistors, the second transistors, and the third transistors are located in a display area.

5. The display panel according to claim 4, wherein the first data line, the second data line, and the third data line are disposed between two adjacent source lines in the row direction, wherein the display panel further comprises:
connection lines, each spanning the corresponding third data line to connect the corresponding second data line and one of the second transistors.

6. The display panel according to claim 5, wherein each of the connection lines comprises:
a first connection portion disposed in a layer same as at least one layer of the second transistors; and
a second connection portion electrically connected to the first connection portion through a via and disposed at a layer same as a layer of the data lines.

7. The display panel according to claim 3, wherein the plurality of first sub-pixels located in the same row of the plurality of pixel repeating units are connected to one of the first demultiplexing lines, the plurality of second sub-pixels located in the same row of the plurality of pixel repeating units are connected to one of the second demultiplexing lines, and the plurality of third sub-pixels located in the same row of the plurality of pixel repeating units are connected to one of the third demultiplexing lines.

8. The display panel according to claim 1, wherein in one of the pixel repeating units, polarity of the first sub-pixel column is opposite to polarity of the second sub-pixel column, and the polarity of the first sub-pixel column is the same as polarity of the third sub-pixel column; and
in two adjacent pixel repeating units, polarity of the third sub-pixel column in one of the pixel repeating units is opposite to polarity of the first sub-pixel column in the other of the pixel repeating units.

9. A display panel, comprising:
a plurality of pixel repeating units, each of the pixel repeating units comprising a first sub-pixel column, a second sub-pixel column, and a third sub-pixel column that are arranged in a row direction, wherein the first sub-pixel column comprises a plurality of first sub-pixels arranged in a column direction, the second sub-pixel column comprises a plurality of second sub-pixels arranged in the column direction, the third sub-pixel column comprises a plurality of third sub-pixels arranged in the column direction, and wherein the plurality of pixel repeating units comprise a first pixel repeating unit and a second pixel repeating unit disposed adjacent to the first pixel repeating unit; and
a plurality of source lines, wherein one of the source lines is disposed between the first pixel repeating unit and the second pixel repeating unit,
wherein the one of the source lines is electrically connected to the first sub-pixel column of the second pixel repeating unit through a plurality of first transistors, the one of the source lines is electrically connected to the third sub-pixel column of the second pixel repeating unit through a plurality of third transistors, and the one of the source lines is electrically connected to the second sub-pixel column of the first pixel repeating unit through a plurality of second transistors.

10. The display panel according to claim 9, further comprising a first auxiliary source line, disposed on one side of the plurality of pixel repeating units and connected by the second transistors to the second sub-pixel column of one of the pixel repeating units adjacent to the first auxiliary source line.

11. The display panel according to claim 10, further comprising a second auxiliary source line disposed on the other side of the plurality of pixel repeating units, wherein the second auxiliary source line is connected to the first sub-pixel column and the third sub-pixel column of one of the pixel repeating units adjacent to the second auxiliary source line respectively through the plurality of first transistors and the plurality of third transistors.

12. The display panel according to claim 9, further comprising:
a plurality of data lines, comprising a first data line electrically connected to the first sub-pixel column of the second pixel repeating unit, a third data line electrically connected to the third sub-pixel column of the second pixel repeating unit, and a second data line electrically connected to the second sub-pixel column of the first pixel repeating unit;
wherein the first transistors are electrically connected to the first data line, the second transistors are electrically connected to the second data line, and the third transistors are electrically connected to the third data line.

13. The display panel according to claim 12, further comprising:
first demultiplexing lines, wherein gates of the plurality of first transistors are electrically connected to the first demultiplexing lines, sources of at least one of the first transistors corresponding to one of the pixel repeating units are electrically connected to one of the source lines, and drains of at least one of the first transistors corresponding to the one of the pixel repeating units are electrically connected to the corresponding first data line;
second demultiplexing lines, wherein gates of the plurality of second transistors are electrically connected to the second demultiplexing lines, sources of at least one of the second transistors corresponding to the one of the pixel repeating units are electrically connected to the corresponding one of the source lines, and drains of at least one of the second transistors corresponding to the one of the pixel repeating units are electrically connected to the corresponding second data line; and
third demultiplexing lines, wherein gates of the plurality of third transistors are electrically connected to the third demultiplexing lines, sources of at least one of the third transistors corresponding to the one of the pixel repeating units are electrically connected to the corresponding one of the source lines, and drains of at least one of the third transistors corresponding to the one of the pixel repeating units are electrically connected to the corresponding third data line.

14. The display panel according to claim 13, wherein all of the first transistors, the second transistors, and the third transistors are located in a display area.

15. The display panel according to claim 14, wherein the first data line, the second data line, and the third data line are disposed between two adjacent source lines in the row direction, wherein the display panel further comprises:
connection lines, each spanning the corresponding third data line to connect the corresponding second data line and one of the second transistors.

16. The display panel according to claim 15, wherein each of the connection lines comprises:
a first connection portion disposed in a layer same as at least one layer of the second transistors; and
a second connection portion electrically connected to the first connection portion through a via and disposed at a layer same as a layer of the data lines.

17. The display panel according to claim 13, wherein the plurality of first sub-pixels located in the same row of the plurality of pixel repeating units are connected to one of the first demultiplexing lines, the plurality of second sub-pixels located in the same row of the plurality of pixel repeating units are connected to one of the second demultiplexing lines, and the plurality of third sub-pixels located in the same row of the plurality of pixel repeating units are connected to one of the third demultiplexing lines.

18. The display panel according to claim 9, wherein in one of the pixel repeating units, polarity of the first sub-pixel column is opposite to polarity of the second sub-pixel column, and the polarity of the first sub-pixel column is the same as polarity of the third sub-pixel column,; and
in two adjacent pixel repeating units, polarity of the third sub-pixel column in one of the pixel repeating units is opposite to polarity of the first sub-pixel column in other one of the pixel repeating units.

19. An electronic terminal comprising the display panel according to claim 9.

20. The electronic terminal according to claim 19, wherein the display panel further comprises a first auxiliary source line disposed on one side of the plurality of pixel repeating units and connected by the second transistors to the second sub-pixel column of one of the pixel repeating units adjacent to the first auxiliary source line.
